(19) United States
(12) Patent Application Publication
(10) Pub. No.: US 2015/0323437 A1
(43) Pub. Date: Nov. 12, 2015

(54) APPARATUS AND METHOD TO MEASURE DUROMETER HARDNESS AT, ABOVE, AND BELOW ROOM TEMPERATURE

(71) Applicant: Antonio Paesano, Newark, DE (US)

(72) Inventor: Antonio Paesano, Newark, DE (US)

(73) Assignee: The Boeing Company, Chicago, IL (US)

(21) Appl. No.: 14/271,856

(22) Filed: May 7, 2014

(51) Int. Cl. G01N 3/42; G01N 3/54

(52) U.S. Cl. CPC G01N 3/42; G01N 3/54

(57) ABSTRACT

An apparatus and its method of use to measure indentation hardness of rubber materials at, above or below room temperature according to the standard test method ASTM D2240.

### FIELD

This disclosure pertains to an apparatus and its method of use in measuring indentation hardness of rubber materials at, above or below room temperature according to the standard test method ASTM D2240.

### BACKGROUND

Hardness is the most important and widely measured and reported property of rubber materials. This is due to it being inexpensive to measure and it serving as a proxy for the Young's Modulus of the rubber material.

Measuring hardness of rubber materials is often done according to the standard test method ASTM D2240. This method basically involves using a durometer for measuring the durometer hardness of the rubber materials.

Durometers are designed for use at room temperature. Therefore, the durometer hardness according to ASTM D2240 can only be measured at room temperature.

### SUMMARY

The apparatus and method of this disclosure measures indentation hardness of rubber materials at, above or below room temperature using the durometer method described in the standard test method ASTM D2240. The apparatus combines together a testing instrument called a dynamic mechanical analyzer (DMA) and a durometer indentor.

The dynamic mechanical analyzer is of a type having co-axially aligned upper and lower shafts with specimen holders positioned between the two shafts. In the apparatus of this disclosure, the specimen holders are removed from the upper and lower shafts.

A platen is attached to the lower shaft. The platen has a flat, horizontal surface that is dimensioned to receive and support a rubber specimen to be tested.

A durometer indentor is attached to the upper shaft with the indentor tip directed toward the platen surface.

The rubber specimen to be tested is positioned on the platen surface. The specimen is centered below the indentor tip.

The dynamic mechanical analyzer temperature chamber is then closed around the test specimen. The control system or control software of the dynamic mechanical analyzer is then activated by an operator. The temperature chamber then brings the test specimen to the desired temperature.

The control system then controls the indentor to move toward the platen surface and the test specimen supported on the platen surface. The indentor tip is moved into the test specimen a predetermined distance at a constant speed for a predetermined period of time in accordance with the standard test method ASTM D2240 for durometer hardness. The control system could alternatively, or additionally, move the specimen toward the indentor tip.

A position sensor of the dynamic mechanical analyzer measures the indentor movement and a load sensor measures the specimen reaction force periodically during the test time period. The control system of the dynamic mechanical analyzer provides an electronic data file with values of force, indentor displacement, and the time period of the test along with a force-displacement chart for the specimen.

In this manner, the apparatus and its method of use are capable of measuring the hardness of rubber materials at, above and below room temperature according to the standard test method ASTM D2240.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a schematic representation of a side elevation view of a dynamic mechanical analyzer that has been modified with a durometer indentor.

FIG. 2 is a schematic representation of the dynamic mechanical analyzer of FIG. 1 with the temperature chamber closed enclosing a rubber test specimen and the durometer indentor.

FIG. 3 is a schematic representation of partial views of the dynamic mechanical analyzer upper and lower shafts with a platen attached to the lower shaft, the durometer indentor attached to the upper shaft and a rubber test specimen positioned on the platen surface directly below the indentor.

FIG. 4 is a flow diagram of the method of this disclosure.

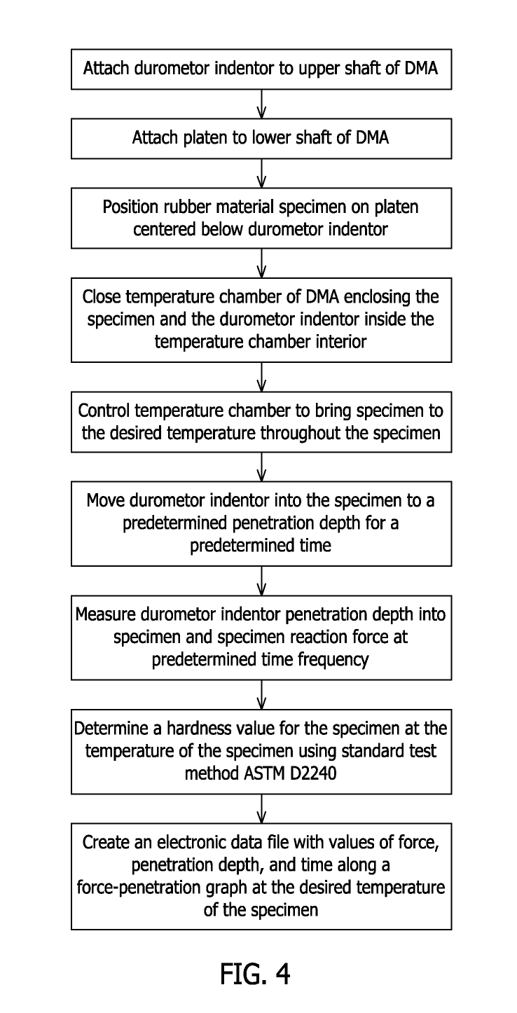

### DETAILED DESCRIPTION

As stated earlier, the apparatus and method of this disclosure measure indentation hardness of rubber materials at, above or below room temperature (23 degrees Celsius) according to the standards set forth by the American Society for Testing and Materials at ASTM D2240, which is incorporated herein by reference. The apparatus 12 combines together a dynamic mechanical analyzer (DMA) 14 and a durometer indentor 16.

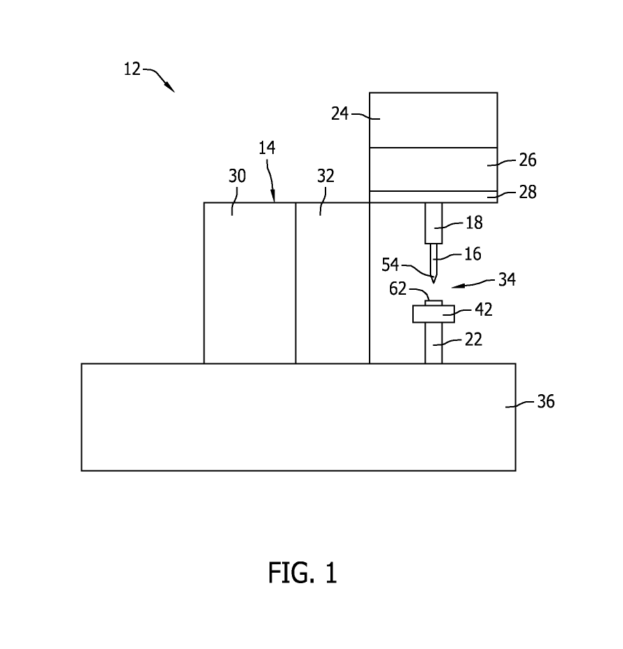

The dynamic mechanical analyzer 14 is represented in FIGS. 1-3. There are many different types of dynamic mechanical analyzers 14 that could be used for the apparatus 12. In the apparatus 12, the dynamic mechanical analyzer 14 is of a type having coaxially aligned, cylindrical upper 18 and lower 22 shafts.

The dynamic mechanical analyzer 14 of the apparatus 12 is set to operate in a tension and compression mode. In this mode a drive mechanism 24 of the analyzer. is selectively operable to move the upper shaft 18 downwardly toward the lower shaft 22 and to move the upper shaft 18 upwardly away from the lower shaft 22.

The dynamic mechanical analyzer 14 also includes a load sensor device 26 and a position sensor device 28. The position sensor device 28 is operatively connected with the upper shaft 18 and is operable to measure the movement of the upper shaft 18, the rate of upper shaft 18 movement or the speed of the upper shaft 18. The load sensor device 26 is operatively connected with the upper shaft 18 and is operable to measure a reaction force exerted by the specimen on the upper shaft 18 opposing the downward movement of the upper shaft 18.

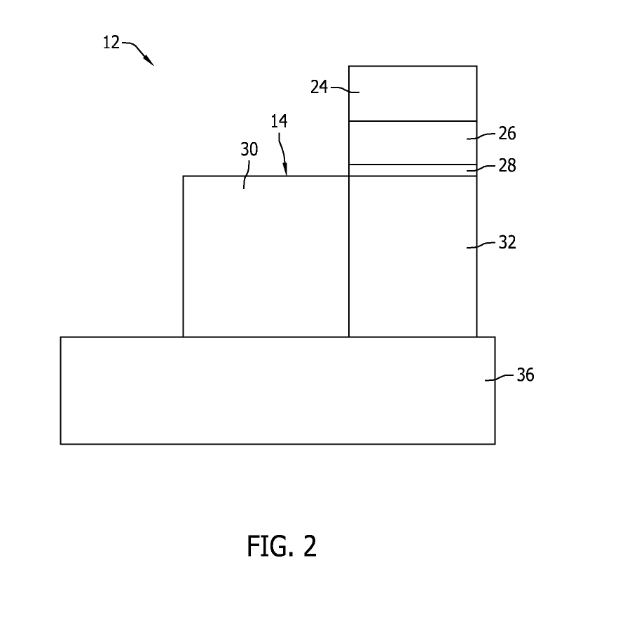

The dynamic mechanical analyzer 14 also includes a temperature chamber 30. The temperature chamber 30 is basically a forced convection laboratory oven. It includes top and bottom coiled heaters that are capable of heating the interior of the temperature chamber 30 to an accurate and precise temperature desired by a user of the apparatus. Closed loop controls of the analyzer 14 control the temperature inside the chamber 30. Additionally, the temperature chamber 30 is also provided with means for cooling the interior of the chamber. Again, the closed loop controls of the analyzer 14 control the cooling of the interior of the temperature chamber 30 to an accurate and precise temperature desired by the user. The temperature chamber 30 is positioned to one side of the upper shaft 18 and lower shaft 22. A door 32 of the temperature chamber is movable between an open position represented in FIG. 1 that provides access to the interior 34 of the chamber and to the upper 18 and lower 22 shafts, and a closed position represented in FIG. 2 where the temperature chamber 30 encloses the upper 18 and lower 22 shafts. The temperature chamber 30 can have any other design that results in a thermally insulated enclosure of the upper shaft 18 and lower shaft 22 and specimen and indentor tip 16.

The dynamic mechanical analyzer 14 also includes a closed loop control system 36 or control software that controls the operations of the analyzer 14 yet to be described.

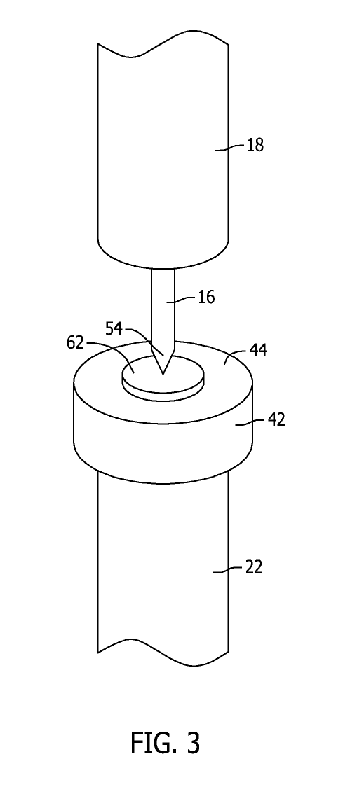

The dynamic mechanical analyzer 14 is modified with a platen 42 that is attached to the upper end of the lower shaft 22. The platen 42 can be removably attached to the lower shaft 22 by a screw threaded connection or any other equivalent mechanical connection that securely holds the platen 42 to the lower shaft 22. The platen 42 is represented in FIGS. 1 and 3 as having a general cylindrical configuration. However, the platen 42 can have any other configuration that enables the platen 42 to be enclosed in the temperature chamber 30. The platen 42 has a flat, horizontal top surface 44. The top surface 44 is dimensioned to receive and support a specimen that is to be tested by the apparatus 12. The platen top surface 44 is centered relative to the coaxial upper shaft 18 and lower shaft 22.

The dynamic mechanical analyzer 14 of the apparatus 12 is also modified with an indentor 16. Specifically, the indentor 16 is a durometer indentor that is compliant with the standards of ASTM D2240. In the example of the indentor 16 shown, the indentor 16 has a tip 54 with a conical configuration. This is only one example of the configuration of the indentor tip 54. The indentor 16 could have a tip 54 designed as a type A, D, B, C, DO, E, M, O, OO, OOO, OOO-S, R, or any other type included in the standard test method for example ASTM D2240. The indentor 16 is removably attached to the upper shaft 18 by screw threading or any other equivalent mechanical attachment with the indentor tip 54 directed downwardly toward the center of the platen top surface 44. The length of the indentor 16 attached to the upper shaft 18 is coaxial with the coaxial upper 18 and lower 22 shafts. With the indentor 16 attached to the upper shaft 18, the center axis of the indentor 16 is perpendicular to the platen top surface 44.

The method of using the apparatus 12 involves a sequence of steps taken by an operator of the apparatus 12 to set up the test parameters on the dynamic mechanical analyzer 14, place the test sample on the platen surface 44, perform the test and analyze the results.

The test specimen 62 is represented in FIGS. 1 and 3. As stated earlier, the test specimen 62 is a rubber material. However, tests on other equivalent types of materials could be performed by the apparatus 12. For example, polymers whose hardness falls within the rubber hardness range. The test specimen geometry must comply with the standard test method ASTM D2240. The test specimen 62 is positioned on the platen top surface 44 and is centered below the indentor tip 54. The door 32 of the temperature chamber 30 is then closed, enclosing the test specimen 62 supported on the platen top surface 44 and the indentor tip 54 in the temperature chamber interior 34.

The apparatus 12 is then controlled by the operator and the apparatus control system 36 to bring the temperature of the test specimen 62 in the temperature chamber 30 to the desired temperature for the test. The test specimen 62 is kept at the predetermined temperature for a period of time to allow the test specimen 62 to reach thermal equilibrium throughout its volume. The temperature of the specimen 62 is reported by a display of the dynamic mechanical analyzer 14. The temperature of the specimen 62 could also be checked by a thermocouple attached to the specimen 62. A consistent temperature of the specimen 62, either above room temperature or below room temperature, is reached by the dynamic mechanical analyzer 14. The heating or cooling source of the temperature chamber 30, the insulation of the chamber, the chamber small size, and adequate dwell time result in the consistent temperature throughout the entire specimen.

With the test specimen 62 at the predetermined temperature, the upper shaft 18 is then controlled to move the indentor 16 downward toward the platen top surface 44 and the test specimen 62 supported on the surface. The indentor tip 54 is moved into the test specimen 62 at a constant speed. The speed is set to have the indentor tip 54 penetrate the test specimen 62 to the selected distance in approximately 1 second, as in a durometer hardness test, or any other time chosen.

The position sensor device 28 of the dynamic mechanical analyzer 14 measures the movement distance of the indentor tip 54 and the load sensor device 26 measures the reacting force exerted by the test specimen 62 on the indentor tip 54 within a predetermined time frequency, preferably every second or less. The control system 36 of the dynamic mechanical analyzer 14 creates an electronic data file with the values of force, indentor tip displacement, and time during the test, along with a force-displacement chart.

When the test is complete the control system 36 controls the drive mechanism 24 to raise the indentor 16. The door 32 of the temperature chamber 30 can then be opened and the specimen 62 removed.

The apparatus 12 enables measuring hardness of rubber materials at, above and below room temperature in an accurate and precise way according to the standard test method ASTM D2240 for rubber hardness measurements. It minimizes operator variation because the load is applied to the specimen 62 by the dynamic mechanical analyzer 14 in a machine controlled way. The apparatus 12 can operate at a wide range of temperatures, for example −150 C to +610 C. The apparatus 12 permits the design of rubber components for high and/or low-temperature applications with better service performance and longer service life.

As various modifications could be made in the construction of the apparatus and its method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. An apparatus for measuring a hardness of a specimen at various different temperatures of the specimen, the apparatus comprising:
a platen having a surface that is dimensioned to receive and support the specimen on the surface;
an indentor above the platen surface, the indentor having a tip at a bottom end of the indentor, the tip being directed toward the platen surface;
a drive mechanism operatively connected to the indentor, the drive mechanism being operable to selectively move the indentor downward toward the platen and the specimen supported on the platen surface to force the indentor tip into the specimen, and move the indentor upward away from the platen and the specimen supported on the platen surface;
a temperature chamber that is selectively closable to enclose the specimen supported on the platen surface and the indentor tip inside the temperature chamber and openable to provide access to the specimen supported on the platen surface, the temperature chamber being operable to selectively change a temperature of the specimen enclosed in the temperature chamber to a predetermined temperature and hold that temperature for a chosen time duration; and,
a control system operatively connected to the drive mechanism to control movement of the indentor and operatively connected to the temperature chamber to control the temperature of the specimen enclosed in the temperature chamber.

2. The apparatus of claim 1, further comprising:
the temperature chamber being operable to increase and maintain the temperature of the specimen enclosed in the temperature chamber.

3. The apparatus of claim 1, further comprising:
the temperature chamber being operable to decrease and maintain the temperature of the specimen enclosed in the temperature chamber.

4. The apparatus of claim 1, further comprising:
the temperature chamber having coaxially aligned upper and lower shafts, the platen being attached to the lower shaft and the indentor being attached to the upper shaft.

5. The apparatus of claim 1, further comprising:
the specimen being rubber.

6. The apparatus of claim 1, further comprising:
a position sensor operatively connected to the indentor, the position sensor being operable to measure movement of the indentor.

7. The apparatus of claim 1, further comprising:
a load sensor operatively connected to the indentor, the load sensor being operable to measure a reaction force exerted by the specimen on the indentor.

8. The apparatus of claim 1, further comprising:
the control system being operable to create an electronic data file with the values of force exerted by the specimen on the indentor tip, displacement of the indentor tip into the specimen, a time period of the displacement of the indentor tip into the specimen and a temperature of the specimen.

9. The apparatus of claim 1, further comprising:
the indentor being a durometer indentor.

10. The apparatus of claim 1, further comprising:
a position sensor connected to the indentor, the position sensor being operable to measure a movement rate of the indentor into the specimen; and,
a load sensor connected to the indentor, the load sensor being operable to measure a reacting force exerted by the test specimen on the indentor tip.

11. The apparatus of claim 1, further comprising:
the drive mechanism, the temperature chamber and the control system being parts of a dynamic mechanical analyzer.

12. An apparatus for measuring hardness of a specimen at various different temperatures of the specimen, the apparatus comprising:
a dynamic mechanical analyzer having an upper shaft, a lower shaft, and a temperature chamber that can be closed to enclose the upper shaft and the lower shaft;
a platen that is attached to the lower shaft, the platen having a surface that is dimensioned to receive and support the specimen on the surface;
a durometer indentor that is attached to the upper shaft, the durometer indentor having a tip at a lower end of the durometer indentor that is directed toward the specimen supported on the platen surface;
whereby the dynamic mechanical analyzer is operable to enclose the specimen and the durometer indentor inside the temperature chamber, to bring the specimen to a predetermined temperature and maintain that temperature for a desired period of time, to move the durometer indentor tip into the specimen and to create an electronic data file with values of displacement of the durometer indentor tip into the specimen, a time period of the displacement and a reactive force of the specimen on the durometer indentor tip at the predetermined temperature of the specimen.

13. The apparatus of claim 12, further comprising:
the dynamic mechanical analyzer being operable to increase and maintain the temperature of the specimen.

14. The apparatus of claim 12, further comprising:
the dynamic mechanical analyzer being operable to decrease and maintain the temperature of the specimen.

15. The apparatus of claim 12, further comprising:
the temperature chamber having coaxially aligned upper and lower shafts, the platen being attached to the lower shaft and the indentor being attached to the upper shaft.

16. The apparatus of claim 12, further comprising:
the specimen comprising rubber.

17. A method of measuring hardness of a specimen at various different temperatures of the specimen, the method comprising:
attaching a durometer indentor to an upper shaft of a dynamic mechanical analyzer;
attaching a platen to a lower shaft of the dynamic mechanical analyzer;
positioning the specimen on the platen with the specimen centered below the durometer indentor;
closing a temperature chamber of the dynamic mechanical analyzer enclosing the specimen and the indentor inside the temperature chamber;
controlling the temperature chamber to bring and maintain the specimen to a predetermined temperature throughout the specimen;
moving the durometer indentor into the specimen to a predetermined penetration for a predetermined time;
measuring the durometer indentor penetration into the specimen and the specimen reaction force at a predetermined time frequency and determining a hardness value for the specimen at the temperature of the specimen; and,
the dynamic mechanical analyzer creating an electronic data file with values of force, penetration, and time along a force penetration graph for the temperature of the specimen.

18. The method of claim 17, further comprising:
controlling the temperature chamber to bring and maintain the specimen to a temperature above ambient room temperature.

19. The method of claim 17, further comprising:
controlling the temperature chamber to bring and maintain the specimen to a temperature below ambient room temperature.

20. The method of claim 17, further comprising:
using rubber as the specimen.
